(19) United States
(12) Patent Application Publication
(10) Pub. No.: US 2026/0220719 A1
(43) Pub. Date: Jul. 30, 2026

(54) ENVIRONMENTALLY SUSTAINABLE SCHEDULING OF FOOD PREPARATION WORK ORDERS

(71) Applicant: INTERNATIONAL BUSINESS MACHINES CORPORATION, Armonk, NY (US)

(72) Inventors: Manikandan Padmanaban, Chennai (IN); Jagabondhu Hazra, Bangalore (IN); Sarbajit Kumar Rakshit, Calcutta (IN); Ivan Kayongo, Nairobi (KE)

(21) Appl. No.: 19/041,552

(22) Filed: Jan. 30, 2025

(51) Int. Cl. G06Q 50/06; G06Q 10/1093

(52) U.S. Cl. CPC G06Q 50/06; G06Q 10/1097

(57) ABSTRACT

Systems, methods, and computer program products for predicting and scheduling subtasks for performance by an energy-consuming entity are disclosed. A method may comprise reading energy information; reading weather information; reading entity information; providing the energy information, the weather information, and the entity information as input to a first machine learning model; reading a predicted set of one or more tasks generated by the first machine learning model; identifying a set of one or more subtasks of the set of one or more tasks; providing the energy information and the weather information as input to at least a second machine learning model; reading predicted electrical grid carbon and water intensities generated by the at least second machine learning model; and determining a schedule for completion of the set of one or more subtasks based on the predicted electrical grid carbon and water intensities.

### BACKGROUND

Embodiments of the present disclosure relate to predicting and schedule subtasks for performance by an energy-consuming entity, and more specifically, to optimizing the scheduling to minimize the environmental footprint of the energy-consuming accordingly.

### BRIEF SUMMARY

According to embodiments of the present disclosure, systems, methods of, and computer program products for by an energy-consuming entity are disclosed. A method of predicting and scheduling subtasks for performance by an energy-consuming entity may comprise reading energy information characterizing energy generation at a location of an entity. The energy information may comprise an identification of one or more energy sources. The method may comprise reading weather information characterizing weather parameters at the location. The method may comprise reading entity information characterizing historical tasks completed by the entity and associated cost information. The method may comprise providing the energy information, the weather information, and the entity information as input to a first machine learning model. The method may comprise reading a predicted set of one or more tasks generated by the first machine learning model based on the input thereto. The method may comprise identifying a set of one or more subtasks of the set of one or more tasks. The method may comprise providing the energy information and the weather information as input to at least a second machine learning model. The method may comprise reading a predicted electrical grid carbon intensity generated by the at least second machine learning model based on the input thereto. The method may comprise reading a predicted electrical grid water intensity generated by the at least second machine learning model based on the input thereto. The method may comprise determining a schedule for completion of the set of one or more subtasks based on the predicted electrical grid water intensity and the predicted electrical grid carbon intensity.

### BRIEF DESCRIPTION OF THE DRAWINGS

FIG. 1 is a flow diagram depicting an exemplary method of predicting and scheduling subtasks for performance by an energy-consuming entity, in accordance with one or more embodiments of this disclosure.

FIG. 2 is a flow diagram depicting an exemplary method of predicting and scheduling subtasks for performance by an energy-consuming entity, in accordance with one or more embodiments of this disclosure.

FIG. 3 is a flow diagram depicting an exemplary method of predicting carbon and water footprints of an electrical grid, in accordance with one or more embodiments of this disclosure.

FIG. 4 depicts a computing node according to one or more embodiments of the present disclosure.

### DETAILED DESCRIPTION

The U.S. restaurant industry consumes a third of all electricity in the retail sector. Restaurants consumes nearly 2.5 times more energy per square foot than commercial buildings. Cooking consumes 35% of electricity in the restaurants. Similarly, the kitchen uses around 52% of the water consumed by a restaurant. Most of the existing solutions for minimizing carbon and water footprints in restaurants are focused on using highly energy efficient equipment and water saving products in the restaurant. Throughout the day, the electrical grid carbon intensity varies based on the power generation mix. Similarly, the water intensity of the power generation changes based on the power generation mix. Restaurants generally prepare base food (or ingredients) for dishes in advance of service to reduce overall cooking time of food orders. This preparation further requires electricity and resource use, contributing to the restaurants' carbon and water footprints. Systems, methods, and computer program products for minimizing carbon and water footprints of restaurants (and other entities) are described herein.

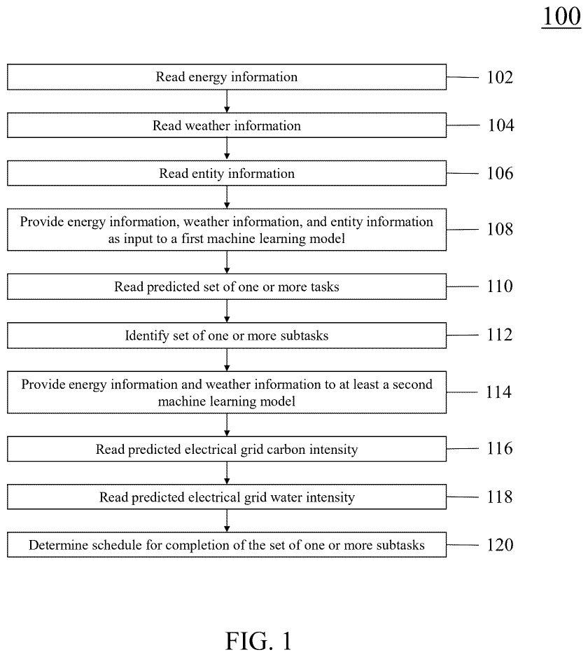

Referring now to FIG. 1 a flowchart illustrating an exemplary method 100 of predicting and scheduling subtasks for performance by an energy-consuming entity is depicted. The operations of method 100 presented below are intended to be illustrative. In some implementations, method 100 is accomplished with one or more additional operations not described and/or without one or more of the operations discussed. The operations of method 100 may be performed in another order. Additionally, the order in which the operations of method 100 are illustrated in FIG. 1 and described below is not intended to be limiting.

In some implementations, method 100 is implemented in one or more processing devices (e.g., a digital processor, an analog processor, a digital circuit designed to process information, a state machine, and/or other mechanisms for electronically processing information). The one or more processing devices may include one or more devices configured through hardware, firmware, and/or software to be specifically designed for execution of one or more of the operations of method 100.

Operation 102 may comprise reading energy information. The energy information may characterize energy generation at a location of an entity. The energy information may comprise an identification of one or more energy sources, historical grid carbon intensity, historical grid water intensity, and/or other information. By way of non-limiting example, the identification of the one or more energy sources is a time series. The time series may indicate a distribution of energy sources used for energy generation at a plurality of points in time. The historical grid carbon intensity may be a time series. Grid carbon intensity is a measure of how much carbon dioxide is released to produce a unit of electricity in an electrical grid. For example, grid carbon intensity may be represented by grams of carbon dioxide per kilowatt hour (kWh) of electricity generated. The historical grid water intensity may be a time series. Electrical grid water intensity is a measure of the amount of water used to generate a unit of energy. For example, electrical grid water intensity may be in the form of liters of water per megawatt hour of electricity generated (L/MWh).

Operation 104 may comprise reading weather information characterizing weather parameters at the location and/or the location of energy generation. The weather information may comprise one or more of a temperature, a wind profile, a precipitation profile, at least one solar irradiance value, and/or other information. For example, the weather information comprises a current solar irradiance value and/or a time series of solar irradiance values for a period of time. The wind profile refers to the variation in wind, speed, and direction with altitude. For example, the wind profile may be influenced by factors such as the synoptic pressure gradient, the temperature profile, and surface roughness. The precipitation profile may characterize one or more depths or other quantities of precipitation, one or more types of precipitation, and/or other information regarding precipitation at the location and/or the location of energy generation.

Operation 106 may comprise reading entity information characterizing historical tasks completed by the entity and associated cost information. Historical tasks are tasks that have been completed by the entity. For example, entity information for a restaurant may characterize individual dishes sold and served by the restaurant. The characterization of each task may comprise one or more of a price, a promotional offer at the time of the task's completion, a time the task was ordered by a customer, a duration of work required to complete the task, subtasks of the task, and/or other information. For example, the entity is associated with a set of applicable tasks. The applicable tasks may be tasks the entity can perform and/or offer for sale. The cost information may comprise a cost for a customer of the entity for completion of each applicable task, a promotional offer associated with the completion of each applicable task, a cost for the entity to complete each applicable task, and/or other information.

Operation 108 may comprise providing the energy information, the weather information, and the entity information as input to a first machine learning model. Operation 110 may comprise reading a predicted set of one or more tasks generated by the first machine learning model based on the input thereto. For example, the entity is a restaurant and/or another foodservice establishment. In such an example, each task may comprise a food order or purchase. By way of non-limiting example, completion of each task comprises preparation of a dish. By way of non-limiting example, completion of each subtask comprises preparation of an ingredient for a dish prepared during completion of that task.

Operation 112 may comprise identifying a set of one or more subtasks of the set of one or more tasks.

Method 100 may comprise reading greenhouse gas information characterizing greenhouse gas emissions of each of the one or more energy sources. Method 100 may comprise reading water information characterizing water consumption of each of the one or more energy sources. Operation 114 may comprise providing one or more of the energy information, the weather information, the greenhouse gas information, the water information, and/or other information as input to at least a second machine learning model. The at least second machine learning model may comprise the second machine learning model and the third machine learning model. The second machine learning model may be configured to generate the predicted electrical grid carbon intensity. The third machine learning model may be configured to generate the predicted electrical grid water intensity. In some implementations, a single machine learning model is configured to generate the predicted electrical grid carbon intensity and the predicted electrical grid water intensity. The at least second machine learning model may comprise at least one spatial temporal learning model.

Operation 116 may comprise reading a predicted electrical grid carbon intensity generated by the at least second machine learning model based on the input thereto.

Operation 118 may comprise reading a predicted electrical grid water intensity generated by the at least second machine learning model based on the input thereto.

In some implementations, method 100 comprises reading a restaurant profile. The restaurant profile may characterize a plurality of tasks performed by the entity. For example, the restaurant profile comprises an identification of a plurality of dishes prepared by the entity, a cuisine of the restaurant, knowledge base information about each dish prepared by the entity, and/or other information characterizing the entity. The knowledge base information may identify one or more ingredients used for each dish, a thermal time mapping for each dish and/or for each ingredient, a mechanical time mapping for each dish and/or for each ingredient, and/or other information. In some implementations, method 100 comprises reading appliance information. The appliance information may characterize one or more appliances for task performance by the entity. Each appliance may consume energy in the form of water, gas, and/or electricity. For example, the one or more appliances may comprise one or more of a stove, an oven, a fridge, a freezer, a stand mixer, a hand mixer, a blender, and/or another appliance. In some implementations, the appliance information comprises one or more of a capacity of an appliance, a thermal time constant of the appliance, a mechanical time constant of the appliance (e.g. in the form of kg/hour), and/or other information characterizing the appliance. For example, the appliance information comprises such information for each appliance used by the entity. Operation 120 may comprise determining a schedule for completion of the set of one or more subtasks. By way of non-limiting example, the schedule may be determined based on one or more of the predicted electrical grid water intensity, the predicted electrical grid carbon intensity, the appliance information, the restaurant profile, and/or other information.

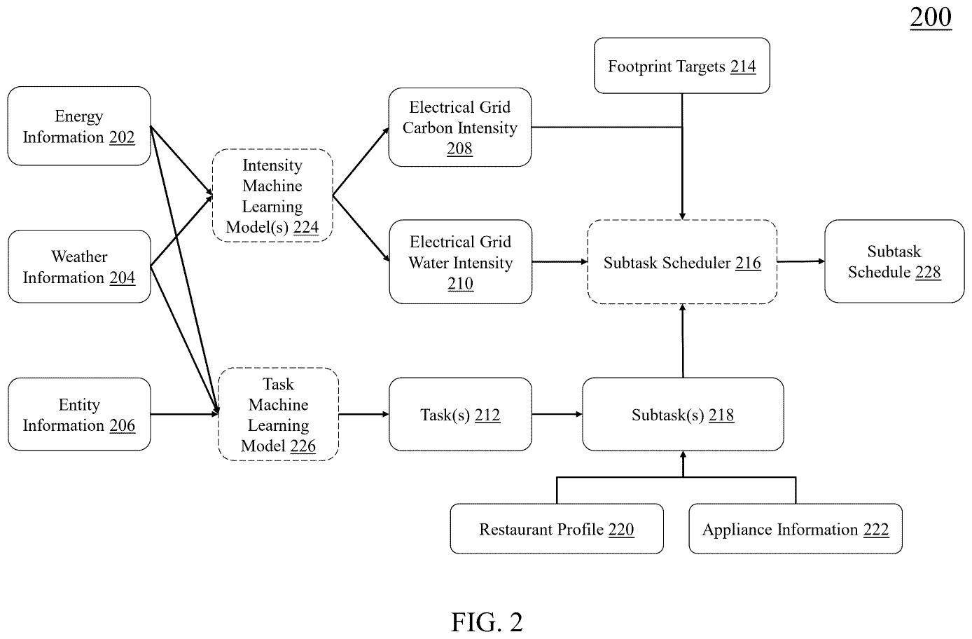

Referring now to FIG. 2, a flowchart illustrating an exemplary method 200 of predicting and scheduling subtasks for performance by an energy-consuming entity is depicted. The operations of method 200 presented below are intended to be illustrative. In some implementations, method 200 is accomplished with one or more additional operations not described and/or without one or more of the operations discussed. The operations of method 100 may be performed in another order. Additionally, the order in which the operations of method 100 are illustrated in FIG. 2 and described below is not intended to be limiting.

In some implementations, method 200 is implemented in one or more processing devices (e.g., a digital processor, an analog processor, a digital circuit designed to process information, a state machine, and/or other mechanisms for electronically processing information). The one or more processing devices may include one or more devices configured through hardware, firmware, and/or software to be specifically designed for execution of one or more of the operations of method 200.

Method 200 may comprise providing energy information 202, weather information 204, and/or other information as input to one or more intensity machine learning models 224. Intensity machine learning model(s) 224 may comprise at least one spatial temporal learning model. Intensity machine learning model(s) may be configured to generate electrical grid carbon intensity 208 and electrical grid water intensity 210 based on the input thereto. Method 200 may comprise providing energy information 202, weather information 204, entity information 206, and/or other information as input to a task machine learning model 226. Task machine learning model 226 may be a spatial temporal learning model. Task machine learning model may be configured to predict one or more tasks 212 based on the input thereto. Task(s) 212 may comprise tasks predicted to be ordered by customers of the entity during a window of time. Energy information 202, weather information 204, and/or entity information 206 may comprise information associated with the window of time. For example, weather information 204 comprises temperature information for the window of time at the location of the entity. For example, entity information 206 comprises identifications of one or more promotional offers to be provided by the entity during the window of time. For example, task(s) 212 identifies a plurality of dishes that are predicted to be ordered on a particular day for a restaurant. For example, task(s) 212 comprises a predicted count of each dish to be ordered.

Method 200 may comprise identifying one or more subtasks 218 for task(s) 212. In some implementations, each subtask 218 is associated with at least one task of task(s) 212. For example, performance of a subtask 218 comprises preparing an ingredient for one or more dishes. By way of non-limiting example, an individual ingredient is used in multiple dishes. For example, one or more of tasks 212 do not have any associated subtasks 218. For example, one or more of tasks 212 has one or more associated subtasks 218. Subtask(s) 218 may be generated based on task(s) 212, restaurant profile 220, appliance information 222, and/or other information. For example, identifying subtask(s) 218 comprises identifying a thermal profile, a perishable time window, and/or other information characterizing each subtask 218. A thermal profile for an individual subtask 218 may comprise a record of temperatures and/or temperature changes of an ingredient throughout its preparation and/or until its use. The perishable time window may indicate a window of time during which the ingredient is suitable for use. For example, the perishable time window indicates a time and/or a duration after preparation at which the ingredient is no longer usable for performance of its associated task(s).

Method 200 may comprise providing subtask(s) 218, electrical grid water intensity 210, electrical grid carbon intensity 208, footprint targets 214, and/or other information as input to subtask scheduler 216. Footprint targets 214 may comprise a carbon footprint target and a water footprint target. Footprint targets 214 may comprise targets for a calendar year, for a fiscal year, for a day, for a month, and/or for another unit of time. Subtask scheduler 216 may be configured to generate subtask schedule 228 based on the input thereto. For example, subtask scheduler 216 may generate subtask schedule 228 for a food service entity. Generating subtask schedule 228 may comprise identifying possible schedules for performing subtask(s) 218.

Generating subtask schedule 228 may comprise determining a weighing factor for each possible schedule for subtask(s) 218. The weighing factor of a schedule may characterize time spent performing subtask(s) 218 and/or an environmental footprint of performing subtask(s) 218 according to the schedule. For example, the environmental footprint is based on the carbon and water footprints of subtask(s) 218. For example, a task's weighing factor is the sum of the completion time of subtask(s) 218, the electrical grid carbon footprint of ingredient preparation, the electrical grid water footprint of ingredient preparation, the electrical grid carbon footprint of ingredient storage, and/or the electrical grid water footprint of ingredient storage. The completion time may be the time that the last subtask performed according to the schedule is completed.

The electrical grid carbon footprint of ingredient preparation may be the carbon footprint of preparing the ingredients of subtask(s) 218 in accordance with the geolocation of ingredient preparation. The electrical grid water footprint of ingredient preparation may be the water footprint of preparing the ingredients of subtask(s) 218 in accordance with the geolocation of ingredient preparation.

The electrical grid carbon footprint of ingredient storage may be the carbon footprint of storing the ingredients of subtask(s) 218 in accordance with the geolocation of subtask performance. The electrical grid water footprint of ingredient preparation may be the water footprint of storing the ingredients of subtask(s) 218 in accordance with the geolocation of subtask performance. For example, the electrical grid carbon and water footprints of ingredient storage may be determined based on one or more of a grid penalty during storage of each ingredient, the durations of storage for each of the ingredients, electrical grid carbon footprints, electrical grid water footprints, and/or other information. For example, the electrical grid carbon footprint of storing an ingredient at a particular time slot of subtask schedule 228 is the product of a grid carbon penalty at the particular time slot, a storage duration for the ingredient, and an electrical grid water footprint at the time of storing the ingredient. For example, the electrical grid water footprint of storing an ingredient at a particular time slot of subtask schedule 228 is the product of a grid water penalty at the particular time slot, a storage duration for the ingredient, and an electrical grid water footprint at the time of storing the ingredient.

For example, generating subtask schedule 228 comprises determining one or more electrical grid resource penalties. A separate penalty may be determined for resources used during the generation of electricity. For example, carbon and water are resources used during the generation of electricity. For example, an electrical grid carbon footprint and/or an electrical grid water footprint may be determined. Determining an electrical grid resource penalty may comprise identifying a footprint target for that resource. The footprint target may be a daily, a monthly, or a yearly carbon footprint target for that resource. An annual footprint target may be converted to a daily footprint target by dividing the annual footprint target by 365 or 365. The footprint target for a given day may be determined based on cumulative past performance. For example, the deviation (Δt) from the footprint target for a given day (n) may be calculated as Δt=(n−1)*daily footprint target−sum of carbon footprints until day n−1. Day n−1 may be the day before the given day. A slope (C_{fC}) for the electrical grid carbon penalty may be dynamically learned from the historical carbon footprints, food demand, forecasted grid carbon intensity, and the cost of purchasing carbon credits. A slope (C_{fW}) for the electrical grid water penalty may be dynamically learned from the historical water footprints, food demand, forecasted grid water intensity, and the cost of purchasing water credits. For example, the slopes are determined using one or more learning models.

The time slot index within subtask schedule 228 may be represented by “S.” The total number of subtasks is represented by “n.” For example, performance of each subtask may comprise performance of one or more operations. For example, the operations may be performed actively (e.g., requiring human interaction) and/or passively (e.g., prepared by an appliance or another tool). The total number of electrical appliances to be used is represented by “m.” The total number of operations of the i^{th} subtask is represented by “nᵢ.” Indices “i” and “h” may be used to identify the index of a subtask. The processing time of the k^{th} operation of the i^{th} subtask is represented by “tᵢₖⱼ.” Indices “k” and “g” may be used to identify the index of an operation. The processing time of a particular operation may be the time it takes to perform the k^{th} operation using a j^{th} appliance (or tool). The decision variables of the optimization framework may be the completion time slots for each operation of each job and whether each appliance is selected for each operation. The completion time slot of the k^{th} operation of the i^{th} subtask may be represented by “cᵢₖₛ.” Whether the j^{th} appliance is selected for the k^{th} operation may be represented by “xᵢₖⱼₛ.”

“F_{CS}” may be used to represent the carbon footprint of the electrical grid at the S^{th} time slot. “F_{WS}” may be used to represent the water footprint of the electrical grid at the S^{th} time slot. “C_{fC}” may be used to represent the weighing factor for the carbon footprint of the electrical grid. The weighing factor for the carbon footprint of the electrical grid may be the electrical grid carbon penalty at time slot S. “C_{fW}” may be used to represent the weighing factor for the water footprint of the electrical grid. The weighing factor for the water footprint of the electrical grid may be the electrical grid water penalty at time slot S. “Htᵢₖⱼ” may be used to represent the duration of ingredient storage. For example, the duration may be in hours, minutes, seconds, and/or another unit of time. For example, the duration of ingredient storage may be the expected usage time minus the time of completing preparation of the ingredient.

In some implementations, generating subtask schedule 228 comprises identifying the schedule having the lowest weighing factor of completing each task. In some implementations, generating subtask schedule 228 comprises iterating through each task to identify open time slot(s) for completing that task to minimize the weighing factor of completing that task. “C_{M}” may be used to represent the weighing factor of completing the M^{th} task. In some implementations, generating subtask schedule 228 comprises computing the following optimization framework:

$$min \cdot {C}_{M} = {}_{i = 1 … n}^{max} \{ {C}_{i {n}_{i}} \} + {{{{\sum }_{i = 1 … n ,}}_{j = 1 … m ,}}_{k = 1 … {n}_{i}}}_{S = 1 … T} ( {C}_{fc} {t}_{ikj} {x}_{i k j S} {F}_{C S} + {C}_{fW} {t}_{ikj} {x}_{i k j s} {F}_{W S} ) + {{{{\sum }_{i = 1 … n ,}}_{j = 1 … m ,}}_{k = 1 … {n}_{i}}}_{S = 1 … T} ( {C}_{fc} {Ht}_{ikj} {F}_{C S} + {C}_{fW} {Ht}_{ikj} {F}_{W S} )$$

The optimization framework may be computed such that the following parameters are maintained:

$${c}_{i k} - {c}_{i ( k - 1 )} \geq {t}_{i k j} , {x}_{i k j} , k = 2 , … , {n}_{i} , ∀ i , j \qquad ( 1 )$$

$$[ ( {c}_{h g} - {c}_{i k} - {t}_{h g j} ) {x}_{h g j} \geq 0 ] ∨ [ ( {c}_{i k} - {c}_{h g} - {t}_{i k j} ) {x}_{i k j} \geq 0 ] , ∀ i , j , g , h \qquad ( 2 )$$

$${\sum }_{{x}_{i k j} ∈ {A}_{i k}} {x}_{i k j} = 1 , ∀ i , k , j \qquad ( 3 )$$

$${c}_{i k} \geq 0 , ∀ i , k \qquad ( 4 )$$

$${x}_{i k j} ∈ 0 , 1 , ∀ i , k , j \qquad ( 5 )$$

$${c}_{i k s} \leq {perish}_{iks}$$

The first and second parameters may represent sequence constraints for the operations. The third parameter may guarantee each appliance is only allocated to one operation at a time. The fourth parameter may ensure the completion times are nonnegative. For example, the fourth parameter ensures subtask schedule 228 only comprises time slots within appropriate time frames for subtask performance. The fifth parameter may ensure that whether an appliance is used is a binary value. For example, the appliance is either being used for an operation or it is not being used. The sixth parameter may ensure that each ingredient is prepared late enough so that it doesn't perish, or spoil, before it is expected to be used. Accordingly, perishᵢₖₛ may represent the time at which an ingredient will spoil respective to the time slot being evaluated.

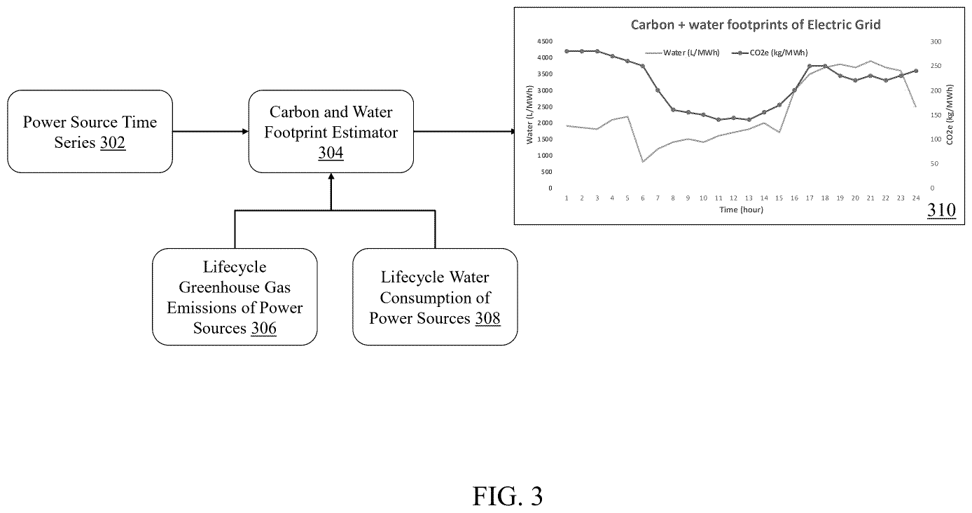

Referring now to FIG. 3, a flowchart illustrating an exemplary method 300 of predicting carbon and water footprints of an electrical grid. Method 300 may comprise providing energy source time series 302, lifecycle greenhouse gas emissions of energy sources 306, lifecycle water consumption of energy sources 308, and/or other information as input to a carbon and water footprint estimator 304. For example, energy information 202 depicted in FIG. 2 comprises energy source time series 302, lifecycle greenhouse gas emissions of energy sources 306, and/or lifecycle water consumption of energy sources 308. For example, carbon and water footprint estimator 304 may comprise intensity machine learning model(s) 224 depicted in FIG. 2. Carbon and water footprint estimator 304 may be configured to generate estimated carbon and water footprints 310 of an electrical grid. Estimated footprints 310 may be generated based on the inputs to carbon and water footprint estimator 304. The estimated carbon footprint and/or the estimated water footprint may be higher when the electrical grid is using energy sources with high footprints. For example, carbon and water footprints 310 may indicate a high water intensity at hour 20 because the electrical grid is using nuclear power.

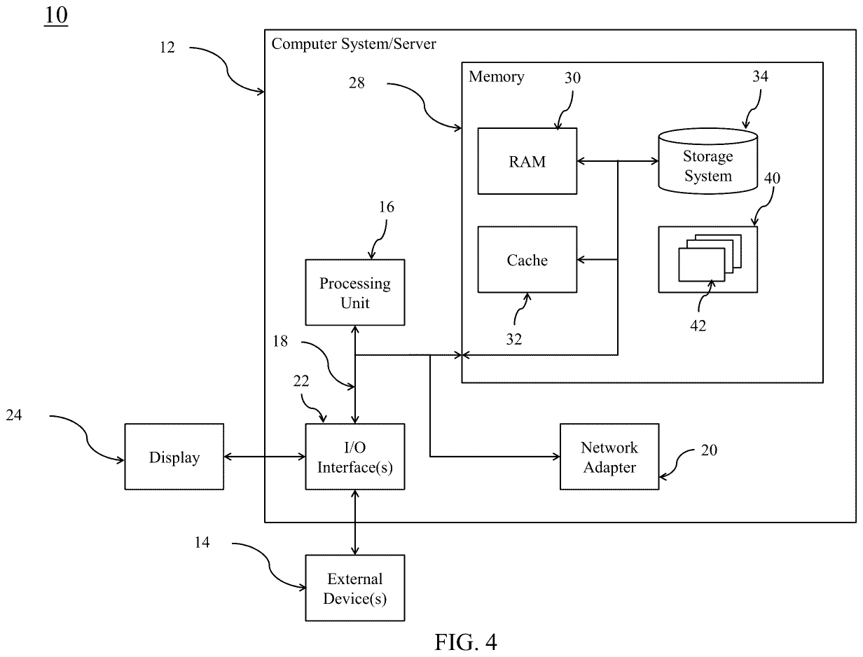

As shown in FIG. 4, computer system/server 12 in computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus, Peripheral Component Interconnect Express (PCIe), and Advanced Microcontroller Bus Architecture (AMBA).

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the disclosure.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

The present disclosure may be embodied as a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method of predicting and scheduling subtasks for performance by an energy-consuming entity, the method comprising:
reading energy information characterizing energy generation at a location of an entity, the energy information comprising an identification of one or more energy sources;
reading weather information characterizing weather parameters at the location;
reading entity information characterizing historical tasks completed by the entity and associated cost information;
providing the energy information, the weather information, and the entity information as input to a first machine learning model;
reading a predicted set of one or more tasks generated by the first machine learning model based on the input thereto;
identifying a set of one or more subtasks of the set of one or more tasks;
providing the energy information and the weather information as input to at least a second machine learning model;
reading a predicted electrical grid carbon intensity generated by the at least second machine learning model based on the input thereto;
reading a predicted electrical grid water intensity generated by the at least second machine learning model based on the input thereto; and
determining a schedule for completion of the set of one or more subtasks based on the predicted electrical grid water intensity and the predicted electrical grid carbon intensity.

2. The method of claim 1, wherein the at least second machine learning model comprises the second machine learning model and a third machine learning model, wherein the second machine learning model is configured to generate the predicted electrical grid carbon intensity, and wherein the third machine learning model is configured to generate the predicted electrical grid water intensity.

3. The method of claim 1, wherein the at least second machine learning model comprises at least one spatial temporal learning model.

4. The method of claim 1, wherein the entity is a restaurant, wherein completion of each task comprises preparation of a dish, wherein completion of each subtask of each task comprises preparation of an ingredient for the dish prepared during completion of that task.

5. The method of claim 4, the method further comprising:
reading a restaurant profile characterizing a plurality of tasks performed by the entity; and
reading appliance information characterizing one or more appliances for task performance by the entity, and wherein
the schedule is further determined based on the restaurant profile and the appliance information.

6. The method of claim 1, the method further comprising:
reading greenhouse gas information characterizing greenhouse gas emissions of each of the one or more energy sources; and
providing the greenhouse gas information as input to the at least second machine learning model.

7. The method of claim 1, the method further comprising:
reading water information characterizing water consumption of each of the one or more energy sources; and
providing the water information as input to the at least second machine learning model.

8. The method of claim 1, wherein the identification of the one or more energy sources is a time series, and wherein the energy information further comprises historical grid carbon intensity and historical grid water intensity.

9. The method of claim 1, wherein the weather information comprises a temperature, a wind profile, a precipitation profile, and a solar irradiance value.

10. The method of claim 1, wherein the entity is associated with a set of applicable tasks, and wherein the cost information comprises a cost for a customer of the entity for completion of each applicable task.

11. A computer program product comprising:
one or more computer-readable storage media; and
program instructions stored on the one or more computer-readable storage media to perform operations comprising:
reading energy information characterizing energy generation at a location of an entity, comprises an identification of one or more energy sources used for energy generation at a location of an entity;
reading weather information characterizing weather parameters at the location;
reading entity information characterizing historical tasks completed by the entity and cost information;
providing the energy information, the weather information, and the entity information as input to a first machine learning model;
reading a predicted set of one or more tasks generated by the first machine learning model based on the energy information, the weather information, and the historical entity information;
identifying a set of one or more subtasks for the set of one or more tasks;
providing the energy information and the weather information as input to at least one machine learning model;
reading a predicted electrical grid carbon intensity generated by the at least one machine learning model based on the energy information and the weather information;
reading a predicted electrical grid water intensity generated by the at least one machine learning model based on the energy information and the weather information; and
determining a schedule for completion of the subtasks of the set of one or more subtasks based on the predicted electrical grid water intensity and the predicted electrical grid carbon intensity.

12. The computer program product of claim 11, wherein the at least second machine learning model comprises the second machine learning model and a third machine learning model, wherein the second machine learning model is configured to generate the predicted electrical grid carbon intensity, and wherein the third machine learning model is configured to generate the predicted electrical grid water intensity.

13. The computer program product of claim 11, wherein the entity is a restaurant, wherein completion of each task comprises preparation of a dish, wherein completion of each subtask of each task comprises preparation of an ingredient for the dish prepared during completion of that task.

14. The computer program product of claim 12, the operations further comprising:
reading a restaurant profile characterizing a plurality of tasks performed by the entity; and
reading appliance information characterizing one or more appliances for task performance by the entity, and wherein
the schedule is further determined based on the restaurant profile and the appliance information.

15. The computer program product of claim 11, the operations further comprising:
reading greenhouse gas information characterizing greenhouse gas emissions of each of the one or more energy sources; and
providing the greenhouse gas information as input to the at least second machine learning model.

16. The computer program product of claim 11, the operations further comprising:
reading water information characterizing water consumption of each of the one or more energy sources; and
providing the water information as input to the at least second machine learning model.

17. A computer system comprising:
a processor set;
one or more computer-readable storage media; and
program instructions stored on the one or more computer-readable storage media to perform operations comprising:
reading energy information characterizing energy generation at a location of an entity, comprises an identification of one or more energy sources used for energy generation at a location of an entity;
reading weather information characterizing weather parameters at the location;
reading entity information characterizing historical tasks completed by the entity and cost information;
providing the energy information, the weather information, and the entity information as input to a first machine learning model;
reading a predicted set of one or more tasks generated by the first machine learning model based on the energy information, the weather information, and the historical entity information;
identifying a set of one or more subtasks for the set of one or more tasks;
providing the energy information and the weather information as input to at least one machine learning model;
reading a predicted electrical grid carbon intensity generated by the at least one machine learning model based on the energy information and the weather information;
reading a predicted electrical grid water intensity generated by the at least one machine learning model based on the energy information and the weather information; and
determining a schedule for completion of the subtasks of the set of one or more subtasks based on the predicted electrical grid water intensity and the predicted electrical grid carbon intensity.

18. The computer system of claim 17, wherein the at least second machine learning model comprises the second machine learning model and a third machine learning model, wherein the second machine learning model is configured to generate the predicted electrical grid carbon intensity, and wherein the third machine learning model is configured to generate the predicted electrical grid water intensity.

19. The computer system of claim 17, wherein the entity is a restaurant, wherein completion of each task comprises preparation of a dish, wherein completion of each subtask of each task comprises preparation of an ingredient for the dish prepared during completion of that task.

20. The computer system of claim 19, the operations further comprising:
reading a restaurant profile characterizing a plurality of tasks performed by the entity; and
reading appliance information characterizing one or more appliances for task performance by the entity, and wherein
the schedule is further determined based on the restaurant profile and the appliance information.
